(19) United States
(12) Patent Application Publication
(10) Pub. No.: US 2025/0279438 A1
(43) Pub. Date: Sep. 4, 2025

(54) THREE-DIMENSIONAL CONDUCTIVE FIBER CURRENT COLLECTOR FOR BATTERIES

(71) Applicant: George Clayton Hansen, Midway, UT (US)

(72) Inventor: George Clayton Hansen, Midway, UT (US)

(21) Appl. No.: 19/066,556

(22) Filed: Feb. 28, 2025

Related U.S. Application Data
(60) Provisional application No. 63/560,926, filed on Mar. 4, 2024.

(51) Int. Cl. H01M 4/80; D04H 1/4234; D06M 10/06; D06M 101/40; H01M 4/02; H01M 4/04; H01M 4/139; H01M 4/62; H01M 4/66

(52) U.S. Cl. CPC H01M 4/806; D04H 1/4234; D06M 10/06; H01M 4/0404; H01M 4/139; H01M 4/626; H01M 4/661; H01M 4/663; H01M 4/667; D06M 2101/40; D10B 2401/16; D10B 2505/00; H01M 2004/027; H01M 2004/028

(57) ABSTRACT

A battery electrode for a battery being either a cathode and/or an anode is provided with enhanced electrical conductivity for use in a battery. The cathode having an active cathode material and/or the anode having an active anode material. The active cathode material is infused into a conductive nonwoven structure and/or the active anode material is infused into a conductive nonwoven structure. The conductive nonwoven structures are selected from metal nonwoven structures (comprised of metal fibers) and metal-coated nonwoven structures (comprised of metal-coated fibers). The metals and metal coatings may be selected from metals including nickel, aluminum, copper, silver, and other metals. The metal-coated nonwoven structure may be a metal-CVD coated nonwoven structure. The conductive nonwoven structure may be secured to a foil current collector using adhesive, by thermal sintering, or other methods of adherence.

### RELATED APPLICATION

This patent application claims the benefit of U.S. Provisional Patent Application Ser. No. 63/560,926 that was filed on Mar. 4, 2024, for an invention titled THREE-DIMENSIONAL CONDUCTIVE FIBER CURRENT COLLECTOR FOR BATTERIES, which is incorporated herein by this reference.

### TECHNICAL FIELD

The present invention relates generally to current collectors for batteries. More specifically, the present invention relates to the use of metal or metal coated nonwoven fiber structures as current collectors in a battery.

### BACKGROUND

The purpose of a battery is to store electrons and then deliver them when needed. Simply described, the electrons are stored in the anode and then released from the cathode. Also, the battery may be described as a series of resistors, the highest resistance being seen at the cathode. This problem is called cathodic impedance. Thus, anything that can be done to improve the conductivity of the cathode is helpful. To a lesser extent, the anode also has some of the same impedance issues.

The most effective material that the industry has found to improve cathode conductivity is a finely divided carbon black, usually noted as Super P or P65. In recent years, carbon nanotubes and graphene have taken front stage, but suffer from cost, manufacturability, and dispersion issues.

Most recently, it had been discovered that the addition of a few percent of high aspect ratio metal coated fibers (such as nickel, copper, or aluminum on a fiber such as carbon (or any other fiber for that matter) cut to a precision length) may be mixed into the active cathode material or the active anode material at a few percent loading to improve the conductivity of either the cathode or the anode, respectively, by several fold. In a typical loading, the resistance of a cathode was reduced fourfold. This results in a significant increase of the battery to deliver more power, more energy, or both.

Also, there exists in the textile broad good industry a category of continuous nonwovens, commonly or more simply referred to as felts or scrims. They can be made from a wide variety of fibers into a broad range of thicknesses (from tens of microns to inches), and into various densities and percent open volume. Such nonwovens find use as filter media, catalyst supports, in thermal management (such as flame arrestors), for carbon-carbon composites such as for brake pads, cleaning pads (scouring pads) and so forth. Even in batteries, they provide a class of separator media. With respect to conductivity, they are standard items of commerce for electromagnetic shielding and lightning strike materials.

Sometimes, in the industry, the term “nonwoven” is written as “non-woven” and both spellings are used interchangeably without a difference in meaning. For purposes of this disclosure, the term “nonwoven” will be used to also mean “non-woven” and may be abbreviated as “NW” in designating materials that comprise a nonwoven portion to the material. Nonwoven materials, fabrics, felts, papers, and/or scrims are randomly oriented, nonwoven three-dimensional fibrous structures that may be fabricated to various thicknesses.

Woven fabrics are made by weaving threads together at prescribed angles, while nonwoven fabrics are made by using random dispersions of fibers. The main difference between woven and nonwoven fabrics is how the threads are arranged, the wovens being orderly and the nonwovens being randomly.

Woven fabrics are usually stronger and more durable than nonwoven fabrics. Woven fabrics are often used for clothing and industrial components. Woven fabrics feel soft and flexible, and you can see the weave (with warp being the vertical thread, yarn or fiber, and weft being the horizontal thread, yarn or fiber) in them.

In contrast, nonwoven fabrics (or sheets) are often more cost-effective than woven fabrics. Nonwoven fabrics have three-dimensional structures that usually makes them more breathable than woven fabrics. Nonwoven fabrics are usually lighter because the three-dimensional structure has more open space than woven fabrics. Further, because the durability of nonwoven fabrics depends on the materials used, the intended use of the fabric will determine which type is most suitable, certain nonwovens are particularly suitable for enhancing conductivity.

The use of nonwovens fabricated from non-conductive fibers has found a home as separator material in batteries, electrically insulating the anode from the cathode, while allowing for transport of the electrolyte between them. Such nonwoven separators are non-conductive and serve a completely different function within a battery.

### SUMMARY OF THE INVENTION

The present invention has been developed in response to the present state of the art, and in response to the problems and needs in the battery art that have not yet been fully solved and is not currently available. The present invention provides a conductive fiber current collector for batteries.

Conductive nonwovens may be made from either metal fibers or metal-coated fibers. Though any fiber may be the basis for metal coating, carbon frequently is a preferred fiber, due to its low density, small diameter and strength and stiffness, all of which contribute to lighter material weight, increased openness, and thin fabrication. Metal-coated fibers (carbon and many other fibers) are much lower in density than their pure metal counterpart. Examples of metal-coated nonwovens include coating fibers with nickel, copper, aluminum, silver, and the like.

These conductive nonwovens (as with all other nonwovens) are fabricated using somewhat standard paper-making processes. The metal may be coated onto or plated to the fiber first, after which time it is chopped and used to make a paper, a three-dimensional nonwoven structure. Alternatively, the fibers may be fabricated into the three-dimensional nonwoven structure, such as a carbon paper, after which the uncoated nonwoven structure may be continuously coated by any number of appropriate metal-plating processes, including electroplating, electroless plating, and chemical vapor deposition (commonly known as CVD). However, the plating process chosen must be capable of plating onto the interior surfaces of the highly complex geometry of the nonwovens. Hence, some coating or plating techniques such as sputtering or physical vapor deposition or spraying may be less suitable because they are “line of sight” techniques, and thus interior surfaces are frequently left uncoated. For purposes of this disclosure the terms “coating” or “coated” shall include plating and plated, such that for example, electroplating and electroless plating shall be considered within the scope of “coating” and electroplated and electroless plated shall be considered within the scope of “coated”.

Although coating or plating the fiber before fabricating the nonwoven may improve conductivity, there are advantages to coating or plating the three-dimensional nonwoven structure after fabrication. If the fiber is first plated or coated, then chopped and made into a paper (a three dimensional structure), the amount of metal coating applied is fixed, which results in a set limit to the achievable conductivity. If one desires greater conductivity, one simply makes the paper (a three-dimensional structure) thicker. By this method, the only way to regulate conductivity is through making the paper thicker. As the paper is usually 88% to 90% open volume, this results in a potential problem of filling that added volume with something (such as a plastic or epoxy resin, or even a battery active mass, as described herein), and that “something” adds weight and may or may not enhance conductivity.

Alternatively, with the process of coating the finished three-dimensional nonwoven structure, one may achieve much greater conductivities by simply applying a thicker metal coating, with de minimis increase of overall thickness, weight, or loss of open volume.

These metal-coated nonwoven materials are items of commerce, available in nickel, copper, and aluminum, from such companies as The Conductive Group, Technical Fiber Products, and Southeast Nonwovens. Though their thickness, density, and percent open can be highly engineered, they are usually about 88% to 90% porous.

The present disclosure demonstrates the use and advantages of electrically conductive nonwovens, fabricated from either metal fibers or metal-coated fibers, in batteries. When conductive nonwovens are incorporated into the cathode or the anode, they act as a highly effective three-dimensional current collector, either in conjunction with the underlying base foil current collector (sometimes herein also referred to interchangeably as the current collector foil), or on their own.

Using electrically conductive nonwovens also brings the added advantage of being able to lay down much thicker electrodes. For instance, normally a a cathode designed to store energy might be up to about 150 grams per square meter and about 60 microns thick. Its poor conductivity does not permit it to be any thicker. But if one desires a cathode to deliver power, it needs to be more conductive and must also be made thinner, thus significantly reducing energy density. Thus, one can design a thicker energy cathode, or a thinner power cathode. But with the present limitations on conductivity in the cathode, one cannot have both power and energy.

As films (i.e, the active material portions of a cathode or an anode) get thicker, they start to run into mechanical integrity problems, similar to a mud flat cracking as it dries. When fibers are added, such as nanofibers, standard chopped fibers or even fibers configured as a nonwoven (as described herein), such structures provide reinforcement to bolster mechanical integrity and help to prevent previously encountered mechanical integrity problems such as cracking and separating.

Furthermore, the consistent and controllable nature of the thickness of the nonwovens during the fabrication process contributes to a high degree of uniformity and allows for the nonwoven to be fabricated to essentially any desired thickness. This in turn allows for cathode or anode films to be fabricated to exceptional thickness (several hundreds of microns) and eventually approach the limits of ionic transport.

These advantages become very important factors in the battery, as they allow for significantly thicker cathodes and anodes which leads to simultaneously increased power density and energy density. While these two parameters are usually a tradeoff of each other, the presently disclosed technology acts to improve both power and energy.

The present disclosure describes a battery cathode with enhanced electrical conductivity for use in a battery, wherein the battery cathode comprises an active cathode material infused into a conductive nonwoven structure. The conductive nonwoven structure may be selected from the group of metal nonwovens and metal-coated nonwovens and the metal used may be determined depending on the chemistry of the battery and/or its operating voltage.

Similarly, the present disclosure describes a battery anode with enhanced electrical conductivity for use in a battery, wherein the battery anode comprises an active anode material infused into a conductive nonwoven structure. Also, the conductive nonwoven structure may be selected from the group of metal nonwovens and metal-coated nonwovens and the metal used may be determined depending on the chemistry of the battery and/or its operating voltage.

The conductive nonwoven structures (whether for use within the cathode or the anode) may comprise a metal nonwoven wherein the metal fibers are selected from the group of metals including nickel, aluminum, copper, silver, and other metals used to enhance conductivity.

The metal-coated nonwoven structures may be coated by metal chemical vapor deposition to form a metal-CVD coated nonwoven structure.

For some exemplary embodiments, the conductive nonwoven structure may stand alone as the current collector, eliminating the need for a current collector foil. However, when the conductive nonwoven structure is attached to a foil current collector, that attachment must be secure, maintaining attachment against repeated expansion and contraction of the materials and preventing detachment that will disrupt or prevent conductivity at the nonwoven/current collector interface. Securing the conductive nonwoven structure to a current collector foil may be accomplished by any suitable form of attachment or connection that does not prevent conductivity at the nonwoven/current collector interface. One exemplary attachment form has the conductive nonwoven structure being adhered to a current collector foil by using an interfacial adhesive that is compatible with the operating chemistry and conditions of battery. This adhesive layer should be at the interface of the nonwoven fibers with the current collector foil but should not extend into the open volume of the nonwoven structure. The adhesives need not be conductive, as the conductive fibers are proximate enough to the current collector foil to provide sufficient conductivity. Another exemplary attachment form has the conductive nonwoven structure attached securely to a current collector by thermal sintering, thereby the nonwoven structure becomes part of the current collector structure.

Once the conductive nonwoven is suitably attached to the current collector foil, the nonwoven is then infused with an active electrode material (whether an active cathode material or an active anode material) into the conductive nonwoven structure by a self-leveling or a mechanically leveled method or any other suitable method.

Again the metal nonwoven structure may have the metal selected from the group of metals including nickel, aluminum, copper, silver, and any other metal used to enhance conductivity. Whereas the metal-coated nonwoven may have the metal selected from the group of metals including nickel, aluminum, copper, and silver.

Depending on the chemistry of the battery and its operating voltage, the use of nickel-coated fibers or aluminum coated fibers or copper coated fibers may be particularly suitable as either a current collector for a cathode or an anode.

These and other features of the exemplary embodiments of the present invention will become more fully apparent from the drawings, examples, and the following description, or may be learned by the practice of the invention as set forth hereinafter.

### BRIEF DESCRIPTION OF THE DRAWINGS

Exemplary embodiments of the present invention are described more fully hereinafter with reference to the accompanying drawings, in which multiple exemplary embodiments of the invention are shown. Like numbers used herein refer to like elements throughout. This invention may, however, be embodied in many different forms and should not be construed as limited to the embodiments set forth herein; rather, these embodiments are provided so that this disclosure will be operative, enabling, and complete. Accordingly, the arrangements disclosed are meant to be illustrative only and not limiting the scope of the invention, which is to be given the full breadth of the appended claims and all equivalents thereof. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at least one of the items but does not exclude a plurality of items of the list. Additionally, the terms “operator”, “user”, and “individual” may be used interchangeably herein unless otherwise made clear from the context of the description.

The drawings are schematic depictions of various components and embodiments and are not drawn to scale. Schematic depictions are being used in this application to assist in the understanding of relative relationships between the components. Understanding that these drawings depict only typical exemplary embodiments of the invention and are not therefore to be considered limiting to its scope, the invention will be described and explained with additional specificity and detail with reference to the accompanying drawings in which:

FIG. 1 is a schematic depiction of an exemplary prior art battery showing only basic component parts.

FIG. 2 is a schematic depiction of an exemplary standard electrode embodiment (representing either a cathode or an anode) showing an active electrode material (cathode or anode) secured to a current collector as generally known in the prior art.

FIG. 3 is a schematic depiction of another exemplary electrode embodiment (representing either a cathode or an anode) showing an active electrode material (cathode or anode) enhanced by an additive and secured to a current collector as known in the prior art.

FIG. 4 a schematic depiction of yet another exemplary electrode embodiment (representing either a cathode or an anode) showing an active electrode material (cathode or anode) enhanced by a branching metal additive and secured to a current collector as known in the prior art.

FIG. 5 is a representative depiction of a selection of fibers (for example, carbon fibers or metal-coated carbon fibers) to be formed into a nonwoven, the fibers bound together by an adhesive binder prior to being formed into the nonwoven.

FIG. 6 is a representative depiction of a selection of fibers (for example, carbon fibers or metal-coated carbon fibers) metal-coated after being formed into a nonwoven, such that the fibers bound together by an adhesive binder and the binder as well are metal coated.

FIG. 7 is a representative depiction of a portion of an exemplary nonwoven embodiment infused with active electrode material or enhanced active electrode material (the active electrode material being active cathode material or active anode material).

FIG. 8 is a representative depiction of an active electrode material infused metal-coated nonwoven adhered to a current collector by a thin adhesive layer.

FIG. 9 is a representative depiction of an active electrode material infused metal-coated nonwoven adhered to a current collector by thermally sintering the metal coating of the nonwoven to the current collector.

FIG. 10 is a representative depiction of an active electrode material infused metal-coated nonwoven absent any current collector.

FIG. 11 is a representative depiction of a double-wide active electrode material infused metal-coated nonwoven adhered to a current collector.

FIG. 12 is a representative depiction of a stand-alone, double-wide active electrode material infused metal-coated nonwoven absent any current collector.

REFERENCE NUMERALS

| | |
|---|---|
| battery 10 | standard cathode or cathode 12 |
| active cathode material 14 | standard anode or anode 16 |
| active anode material 18 | separation barrier or separator 20 |
| anode current collector 22 | cathode current collector 24 |
| cathode tab 26 | cathode lead 28 |
| anode tab 30 | anode lead 32 |
| circuit switch 34 | standard electrode embodiment 36 |
| active electrode material 38 | electrode current collector |
| | (or foil current collector) 40 |
| electrode tab 42 | electrode lead 44 |
| additive 46 | precision chopped fiber or PCF 48 |
| branching metal additive 50 | fibers or metal-coated fibers 52 |
| nonwoven three-dimensional fibrous structure | |
| or nonwoven structure (or NiNW) 54 | |
| system-compatible adhesive binder 56 | binder 58 |
| system compatible organic binder 60 | adhesive layer 62 |
| sintered locations 64 | |
| double arrow A (maximum thickness) | double arrow B (given thickness of X) |
| double arrow C (given thickness of 2X) | |

### DETAILED DESCRIPTION OF THE INVENTION

The exemplary embodiments of the present disclosure will be best understood by reference to the drawings, wherein like parts are designated by like numerals throughout. It will be readily understood that the components of the exemplary embodiments of the present invention, as generally described and illustrated in the figures and examples herein, could be arranged and designed in a wide variety of different arrangements. Thus, the following more detailed description of the exemplary embodiments, as represented in the figures and examples, is not intended to limit the scope of the invention, as claimed, but is merely representative of exemplary embodiments of the disclosure.

This detailed description, with reference to the drawings, describes a representative battery 10 as known in the prior art that operates with a standard cathode 12 made of an active cathode material 14 and a standard anode 16 made of an active anode material 18. The exemplary embodiments of the present invention comprise modified electrodes with increased conductivity that separately or together may be components of an enhanced battery.

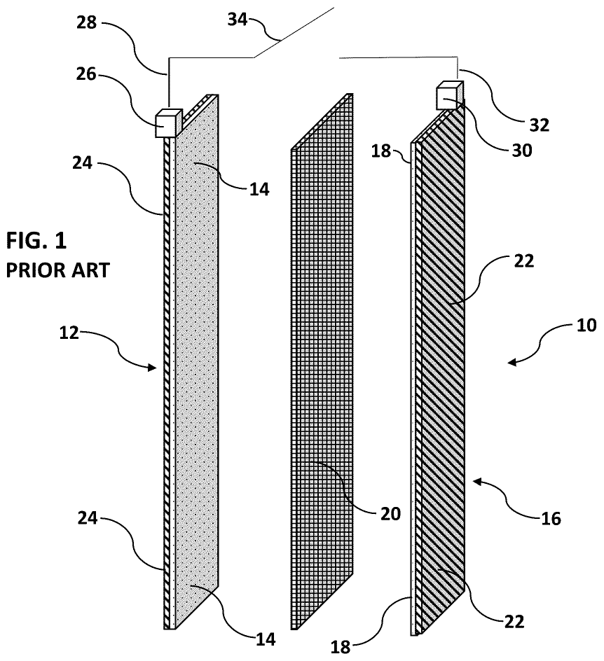

Turning specifically to FIG. 1, the basic components of a representative battery 10 as known in the prior art is depicted schematically. The battery 10 comprises the standard cathode 12 made of the active cathode material 14, the standard anode 16 made of the active anode material 18, an electrolyte (not depicted), a separation barrier or separator 20, an anode current collector 22, a cathode current collector 24, a cathode tab 26, a cathode lead 28, an anode tab 30, an anode lead 32, and a circuit switch 34 each encased within a battery housing (not depicted).

The active cathode material 14 may be any of many cathode compounds known to be of use in batteries; for example, the battery 10 may be a lithium-ion battery 10 and the exemplary active cathode materials 14 may include lithium iron phosphate (LiFePO₄ or LFP) or alternatively lithium nickel manganese cobalt oxide (LiNiMnCoO₂ or NMC) or lithium cobalt oxide (LiCoO₂) or lithium manganese oxide (LiMn₂O₄) or any other cathode material used in lithium-ion batteries, to name a few as examples. In addition, a few percent of a conductivity enhancer, such as carbon black, carbon nanotube or graphene may be added to provide slight improvement in conductivity. The cathode material also contains a small amount of a polymer used as a binder. Other active cathode materials are known to be used in other types of battery systems, and the use of any of these other active cathode materials is contemplated to be within the definition of “active cathode material” as used in this disclosure.

Other active cathode materials are known to be used in other types of battery systems, and the use of any of these other active cathode materials is contemplated to be within the definition of “active cathode material” as used in this disclosure.

The active anode material 18 may be any of the anode materials known to be of use in batteries; again for example, the battery 10 may be a lithium-ion battery 10 and exemplary base anode materials 18 may include carbon, usually as graphite powder, or as silicon, or combinations thereof. In addition, a few percent of a conductivity enhancer, such as carbon black, carbon nanotubes or graphene may be added to provide slight improvement in conductivity. The anode material also contains a small amount of a polymer used as a binder. Other active anode materials are known to be used in other types of battery systems, and the use of any of these other active anode materials is contemplated to be within the definition of “active anode material” as used in this disclosure.

Also, the most used electrolyte in lithium-ion batteries 10 is lithium salt, such as LiPF6 in an organic solution. The key role of the electrolyte is transporting positive lithium ions between the cathode 12 and anode 16, and vice versa.

The battery 10 operates to transport electrons through the system of components. In FIG. 1, in the discharging mode the electron transport starts with the anode current collector 22, then through the anode collector 22/active anode material 18 interface to the active anode material 18. The discharging direction of electron flow is from negative to positive. Positively charged electrons travel within the electrolyte to pass across the separator 20 to the standard cathode 12. The electron is transported through the active cathode material 14 to the active mass/collector interface then moves the electrons out of the cathode current collector 24 to the device it services.

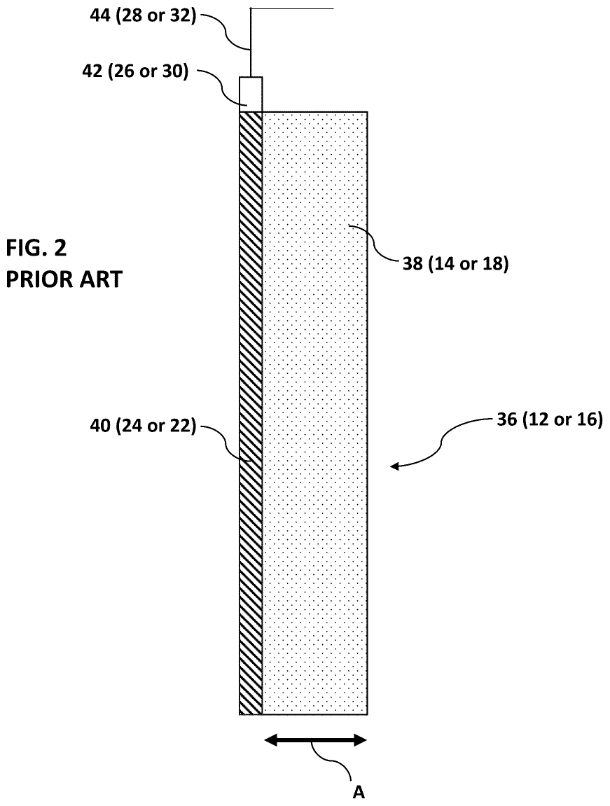

FIG. 2 is a schematic depiction of an exemplary standard electrode embodiment 36 (representing either a cathode 12 or an anode 16) showing an active electrode material 38 (active cathode material 14 or active anode material 18) secured to an electrode current collector 40 (a cathode current collector 24 or an anode current collector 22) as generally known in the prior art. Additionally, the standard electrode embodiment 36 has an electrode tab 42 (a cathode tab 26 or an anode tab 30) and an electrode lead 44 (a cathode lead 28 or an anode lead 32).

For purposes of streamlining this disclosure by reducing the number of figures (because, for example, a depiction of an electrode need not be materially different than the depiction of a cathode or the depiction of an anode), a reference number convention has been adopted; namely, subsets of elements that are part of an all-encompassing set are referenced as A (B or C). For example, all cathodes or all anodes are among the set of electrodes so that the reference number convention is “electrodes (cathodes or anodes)” and when used as reference numerals, in this instance, “36 (12 or 16)”.

The previously mentioned small portion of an adhesive in the cathode or anode paste (i.e., active material, whether active cathode material 14 or active anode material 18, is sometimes herein called paste or film because those skilled in the art use those terms when referring to the active material portions of the cathode or anode), serves the dual function of cohesively binding the components of the paste together and adhesively binding the paste to the foil (i.e., current collector).

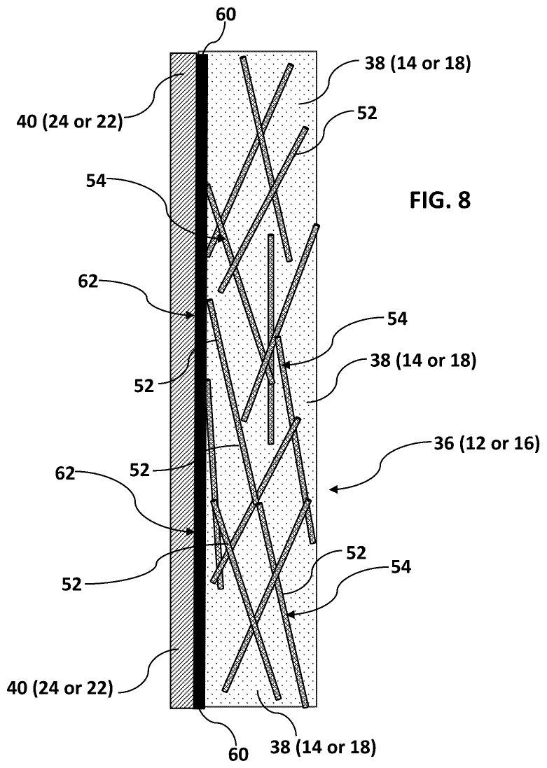

It has been initially observed that adhesion of the nonwoven structure/paste combination to the foil was not consistent. One approach to solve this issue is to employ a thin layer of an appropriate adhesive at the foil/nonwoven interface (see FIG. 8). This adhesive layer 62 must be thick enough to bind the contact points of the nonwoven structure 54 to the foil current collector 40, but thin enough that it does not extend appreciably into the open volume of the nonwoven structure 54, where it would displace available open volume for the active electrode material 38 to occupy. The adhesive layer 62 does not need to be conductive, as the contact points are so thin that they adequately allow for the electrons to move from the nonwoven structure 54 to the foil current collector 40, and do not measurably or significantly add more resistance appreciably to the system. However, it is known in the battery art that most types of adhesives eventually break down at the operating voltages of a battery. To overcome this potential issue, the same system-compatible adhesive binder 56 used to bind the fibers 52 together to form the nonwoven structure 54 may also be used as the system-compatible organic binder 60 to form the adhesive layer 62 for attach the nonwoven structure 54 to the foil current collector 40.

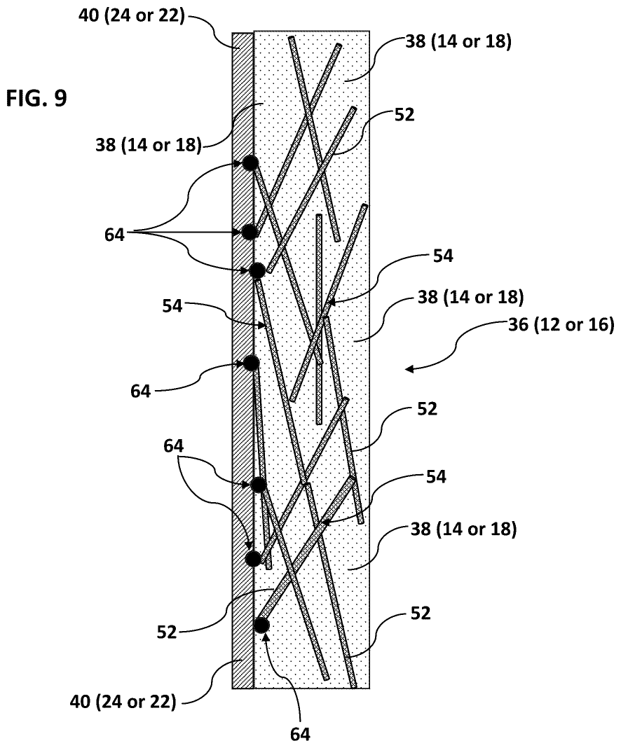

Another exemplary approach that securely attaches the nonwoven structure 54 to the foil current collector 40 is by hot press sintering the nonwoven structure 54 onto the foil current collector 40 (see FIG. 9). Although this can be an expensive and capital intensive process, it assures a complete and permanent adherence.

Whichever of these exemplary attachment processes is chosen; it is performed prior to infusing the final assembly with the active electrode material 38 (whether it be active cathode material 14 or active anode material 18).

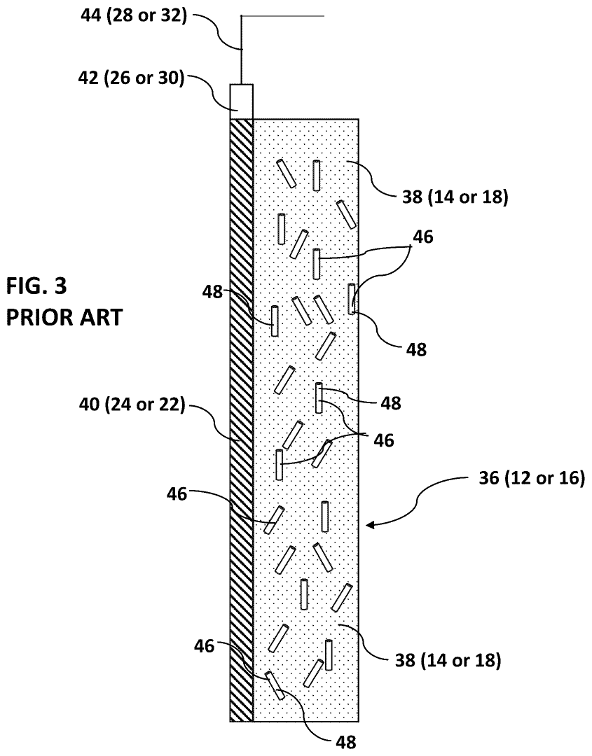

FIG. 3 is a schematic depiction of another exemplary electrode embodiment 36 (representing either a cathode 12 or an anode 16) showing an active electrode material 38 (active cathode material 14 or active anode material 18) enhanced by an additive 46 and secured to an electrode current collector 40 as known in the prior art, particularly as disclosed, taught, and/or claimed in U.S. Pat. No. 11,527,756 (the '756 Patent) and U.S. Pat. No. 11,817,587 (the '587 Patent) each titled as “Resistance Reduction in a Battery and Battery Materials” and each having the same inventor as this application (the teaching and disclosures of each of the '756 Patent and the '587 Patent are hereby incorporated into this application in their entireties by this reference). The additive 46 depicted, for example, may be a precision chopped fiber or PCF 48 or nickel-CVD coated fiber precision chopped or aluminum-CVD coated fiber precision chopped or any other applicable additive disclosed and/or claimed in the '756 Patent and/or the '587 Patent.

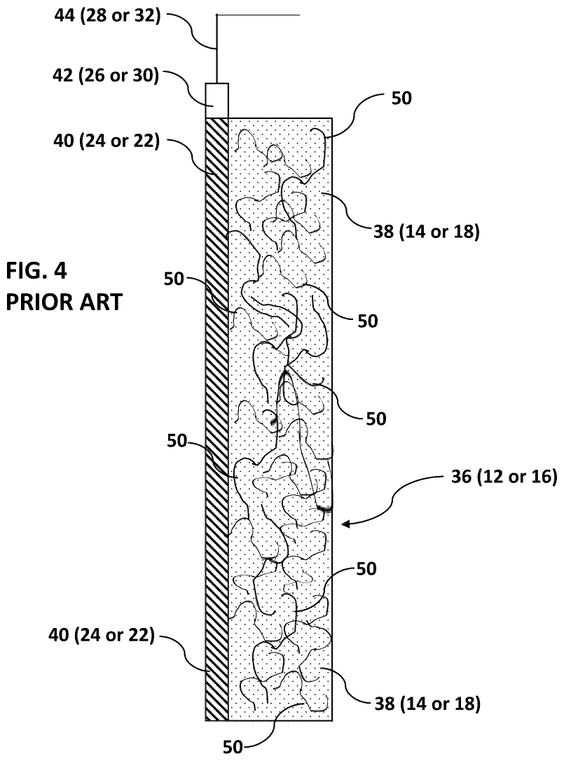

Similarly, FIG. 4 is a schematic depiction of yet another exemplary electrode embodiment 36 (representing either a cathode 12 or an anode 16) showing an active electrode material 38 (active cathode material 14 or active anode material 18) enhanced by a branching metal additive 50 and secured to an electrode current collector 40 as known in the prior art, particularly as disclosed, taught, and/or claimed in U.S. Pat. Nos. 11,527,756 (the '756 Patent) and U.S. Pat. No. 11,817,587(the '587 Patent) each titled as “Resistance Reduction in a Battery and Battery Materials” and each having the same inventor as this application. The branching metal additive 50 depicted, for example, may be a nickel nanostrands (also known as branching nickel strands or BNS) or branching nickel powder such as 255 nickel powder or any other applicable branching additive disclosed and/or claimed in the '756 Patent and/or the '587 Patent.

Further, as disclosed and taught in the '756 Patent and/or the '587 Patent both an additive 46 and a branching additive 50 may be added to the active electrode material 38 to enhance conductivity of the electrode embodiment 36. Separate figures are not deemed necessary to the understanding of the breadth of embodiments using active electrode material 38, to those skilled in the art, either unenhanced (such as shown in FIG. 2), enhanced by an additive 46 (such as shown in FIG. 3), enhanced by a branching metal additive 50 (such as shown in FIG. 4) and/or enhanced by a combination of additive(s) 46 and branching metal additive(s) 50 (such as by combining FIGS. 3 and 4). Rather, it is contemplated that the definitions of “active cathode material” 14 and “active anode material” 18 each include or subsume within those definitions unenhanced and enhanced by an additive 46 and/or by a branching metal additive 50.

Significant improvement in the conductivity of either the anode 16 or the cathode 12 or both creates lower resistivity, not only across or through the respective cathodic or anodic film (i.e., active cathode material 14 and active anode material 18), but also generally across the entire battery cell. As a result, a lower resistance leads to higher voltage to move a given current or move a higher current at a given voltage. This, in turn, leads to faster charging and/or discharging, or the ability to move an electron at greater ease through thicker films, thus increasing battery capacity. Lower resistivity also decreases Joule heating, with a corresponding reduction in temperature and in energy loss. A decrease in operating temperature also results in a more efficient and safer battery.

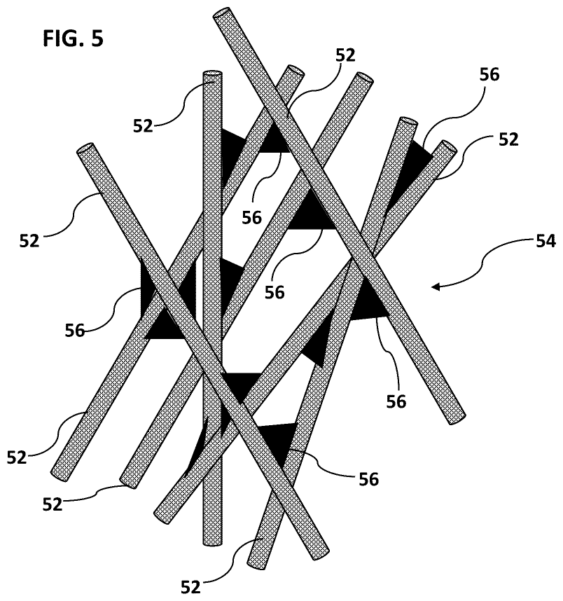

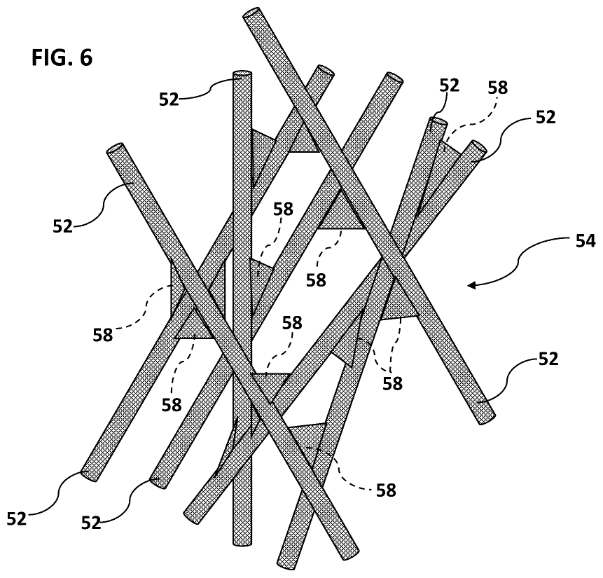

Turning now to FIGS. 5 and 6, a fundamental difference in how the nonwoven is fabricated is illustrated. FIG. 5, for example, is a representative depiction of a selection of fibers 52 (for example, carbon fibers, metal fibers or metal-coated fibers) to be formed into a nonwoven. Fibers 52 to be coated may be selected from among fibers comprising carbon, partially oxidized organic fibers, silica, quartz, silicates, alumina, aluminosilicates, borosilicates, glass, minerals, carbides, nitrides, borides, polymers, cellulose, inorganic fibers, and/or organic fibers. In this instance, the fibers 52 (carbon fibers or other fibers) are coated with a metal coating and are cut to a predetermined length or lengths (typically having fibers of a length longer than the precision chopped fibers as shown in FIG. 3) prior to being formed into a nonwoven structure 54. The length(s) at which the fibers 52 are cut typically are longer than the length of the PCF 48 additive 46 because they have different functions. The PCF 48 is shorter to facilitate dispersion of the PCF 48 into the active electrode material 38, whereas the longer fibers 52 form a nonwoven structure 54 having openness that allows the active electrode material 38 to be infused into the nonwoven structure 54.

To form the metal-coated fibers 52 into the nonwoven structure 54 (a small representative sample is depicted in FIG. 5), the metal-coated fibers 52 are randomly oriented and secured into the nonwoven three-dimensional fibrous structure 54 by applying a system-compatible adhesive binder 56 at points of contact where fibers 52 touch one or more other fibers 52. The principal purpose of the system-compatible adhesive binder 56 is to bind the fibers 52 to form the nonwoven three-dimensional fibrous structure 54 (i.e., randomly lattice-like). Because the system-compatible adhesive binder 56 is not metal coated (as shown in FIG. 5), it may or may not be conductive, and it must be a binder that is compatible with the electrochemical operating conditions of the battery. If the system-compatible adhesive binder 56 is not conductive, it may contribute to conductivity only by securing the points of contact between fibers 52.

Although the nonwoven structure 54 of FIG. 5 (i.e, metal coating the fiber 52 before fabricating the nonwoven structure 54) may increase conductivity of an electrode embodiment 36 appreciably, there is a notable drawback presented by this fabrication technique of metal-coating the fibers 52 before forming the fibers 52 into the nonwoven structure 54. The amount of metal coating on the fibers 52 is fixed before the nonwoven structure 54 is formed, limiting the enhancement of the conductivity to what has been coated pre-fabrication of the nonwoven 54. With this fabrication technique, if more conductivity is desired, it may be accomplished in one of three ways, 1) a thicker metal coating must be pre-planned into the step of metal-coating the fibers 52, or 2) given a metal-coating thickness on the fibers 52, pre-planning to increase the number of metal-coated fibers 52 fabricated into the nonwoven structure 54, or 3) given a metal-coating thickness on the fibers 52, pre-planning to fabricate the nonwoven structure 54 at an increased thickness.

FIG. 6, on the other hand, is a representative depiction of a selection of 52 fibers (for example, carbon fibers or other fibers) metal-coated after being formed into a nonwoven structure 54, such that the fibers 52 bound together by a binder 58 and the binder 58 are metal coated as well. Because the binder 58 is coated after fabrication of the nonwoven structure 54, there is no requirement that the binder 58 be a system-compatible adhesive binder 56, unless the coating process used (such as sputtering, evaporation or spraying, in some instances) does not or might not coat all interior surfaces of the nonwoven structure 54 (whereas using a CVD coating process, for example, will coat all surfaces). The thickness of the metal coating may be engineered to provide the desired conductivity. Simply put, because a given thickness of metal coating provides a given conductivity, one need only increase the thickness of the metal coating to increase conductivity, with de minimis increase in overall thickness, weight, or loss of open volume of the nonwoven structure 54.

Furthermore, because the nonwoven structure 54 provides strength and stiffness to the active electrode material 38 of the electrode embodiment 36, the mechanical integrity problems encountered by active electrode material 38 cracking or separating from the current collector as the thickness of the active electrode material 38 is increased are avoided. The consistent and controllable nature of the thickness of the nonwoven structures 54 during the fabrication process contributes to a high degree of uniformity and allows for the nonwoven structures 54 to be fabricated to essentially any desired thickness. This in turn allows for cathode or anode films of exceptional thickness (several hundreds of microns) and eventually approach the limits of ionic transport.

Another important parameter is the method by which the metal nonwoven structure 54, or metal-coated nonwoven structure 54 may be secured to the underlying foil current collector 40 which has been discussed in detail above.

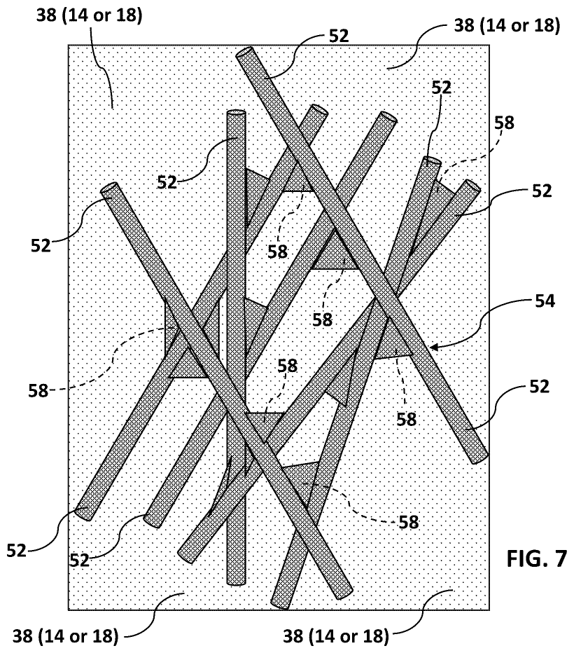

FIG. 7 is a representative depiction of a portion of an exemplary nonwoven structure 54 infused with active electrode material 38 or enhanced active electrode material 38 (including one or more additive 46 and/or one or more branching metal additive 50). The active electrode material 38 being either an active cathode material 14 or active anode material 18. Because the nonwoven structure 54 becomes a conductive augmentation to the foil current collector 40, it operates as a current collector also, dramatically increasing the conductive surfaced area (including interior and exterior surface areas of the open nonwoven structure 54) for current collection.

The result of a thicker and thicker active electrode material 38 in existing battery technology not only presents mechanical integrity problems of cracking and separation (as discussed above) but also places the outermost portions of the active electrode material 38 remotely distant from the foil current collector 40 making current collection from the more remote active electrode material 38 less effective and less efficient. However, by augmenting the foil current collector 40 with nonwoven structure 54 the infused active electrode material 38 at any point within the infused material is closer to a current collection surface (whether it be the foil current collector 40 or the nonwoven structure 54) than the flat foil current collector 40 only.

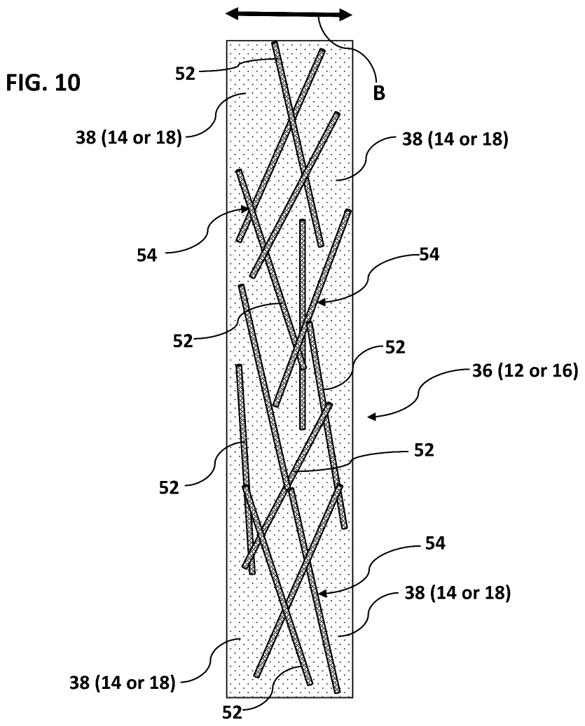

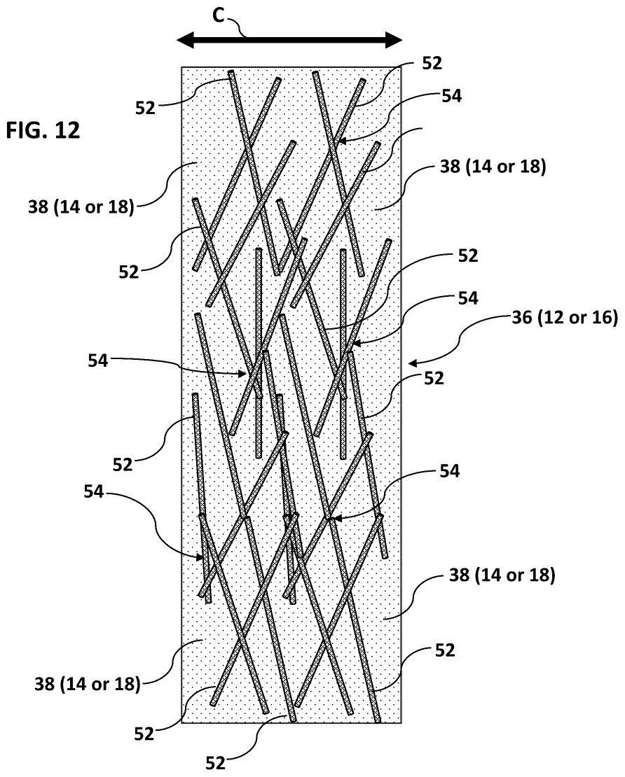

FIGS. 8-12 are representative depictions of illustrative configurations of electrode embodiments 36 wherein FIGS. 8, 9, and 11 show the nonwoven structure 54 augmenting the foil current collector 40 and wherein FIGS. 10 and 12 show the nonwoven structure 54 acting alone as the current collector.

FIG. 8 depicts a nonwoven structure 54 (a metal nonwoven or a metal-coated nonwoven, without the binder shown so not to limit the scope of the depiction) adhered to the foil current collector 40 by a thin adhesive layer 62 (system-compatible adhesive binder 56 or system compatible organic binder 60, as appropriate). The nonwoven structure 54 is infused with active electrode material 38 (unenhanced or enhanced). If the electrode embodiment 36 is a cathode 12, the active electrode material 38 is active cathode material (unenhanced or enhanced). Similarly, if the electrode embodiment 36 is an anode 12, the active electrode material 38 is active anode material (unenhanced or enhanced).

FIG. 9 depicts a nonwoven structure 54 (a metal nonwoven or a metal-coated nonwoven, without the binder shown so not to limit the scope of the depiction) adhered to the foil current collector by thermal sintering at sintered locations 64. The nonwoven structure 54 is infused with active electrode material 38 (unenhanced or enhanced). If the electrode embodiment 36 is a cathode 12, the active electrode material 38 is active cathode material (unenhanced or enhanced). Similarly, if the electrode embodiment 36 is an anode 12, the active electrode material 38 is active anode material (unenhanced or enhanced).

FIG. 10 depicts a stand-alone nonwoven structure 54 (a metal nonwoven or a metal-coated nonwoven, without the binder shown so not to limit the scope of the depiction) not connected to any foil current collector 40. The nonwoven structure 54 is infused with active electrode material 38 (unenhanced or enhanced) to a given thickness X as designated by double arrow B. In this case, the nonwoven structure 54 has sufficient strength and stiffness to provide mechanical integrity to the active electrode material 38 and has sufficient conductive surface area to act as the electrode current collector 40 in lieu of a foil current collector 40. If the electrode embodiment 36 is a cathode 12, the active electrode material 38 is active cathode material (unenhanced or enhanced). Similarly, if the electrode embodiment 36 is an anode 12, the active electrode material 38 is active anode material (unenhanced or enhanced).

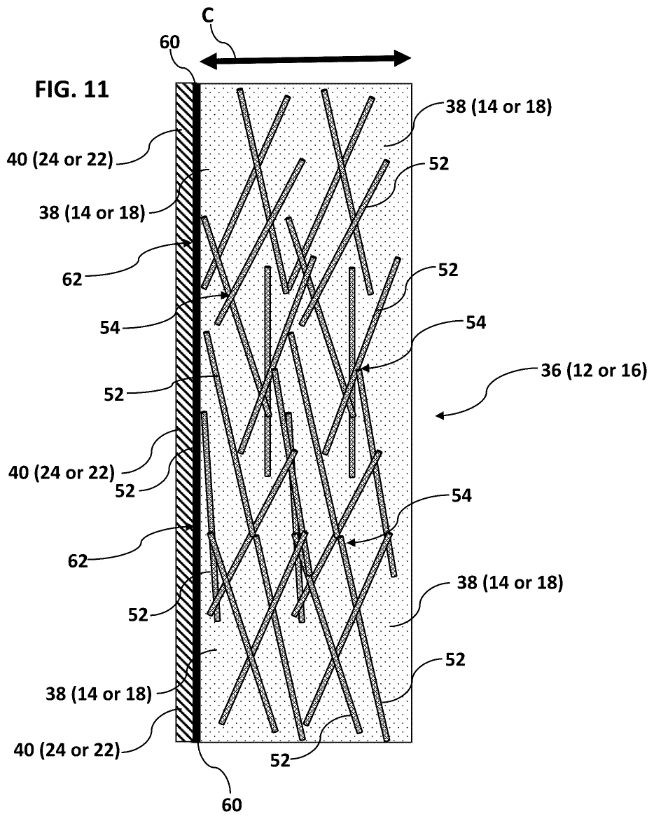

FIG. 11 depicts a nonwoven structure 54 (a metal nonwoven or a metal-coated nonwoven, without the binder shown so not to limit the scope of the depiction) adhered to the foil current collector 40 by a thin adhesive layer 62 similar to the depiction of FIG. 8 (system-compatible adhesive binder 56 or system compatible organic binder 60, as appropriate). However, the nonwoven structure 54 is infused with active electrode material 38 (unenhanced or enhanced) to a greater given thickness 2X, for example, as designated by double arrow C. If the electrode embodiment 36 is a cathode 12, the active electrode material 38 is active cathode material (unenhanced or enhanced). Similarly, if the electrode embodiment 36 is an anode 12, the active electrode material 38 is active anode material (unenhanced or enhanced).

The thickness of 2X is chosen only as an example. As described above, the role of the conductive nonwoven structure 54 is to provide close proximity of all of the active mass to the current collector (i.e., the nonwoven structure 54 as securely attached to the current collector foil 40) at all locations within the active electrode material 38. This then allows for the design of much thicker electrodes 36 without reducing access to a metal conducting porting of the three dimensional current collector. The thickness may be “any X”, so long as the active electrode material 38 is still able to provide the required ionic transport.

FIG. 12 depicts a stand-alone nonwoven structure 54 (a metal nonwoven or a metal-coated nonwoven, without the binder shown so not to limit the scope of the depiction) not connected to any foil current collector 40. The nonwoven structure 54 is infused with active electrode material 38 (unenhanced or enhanced) to a greater given thickness 2X, for example, as designated by double arrow C. In this case as before in FIG. 10, the nonwoven structure 54 has sufficient strength and stiffness to provide mechanical integrity to the active electrode material 38 and has sufficient conductive surface area to act as the electrode current collector 40 in lieu of a foil current collector 40. If the electrode embodiment 36 is a cathode 12, the active electrode material 38 is active cathode material (unenhanced or enhanced). Similarly, if the electrode embodiment 36 is an anode 12, the active electrode material 38 is active anode material (unenhanced or enhanced).

An example of how an exemplary cathode (wherein lithium iron phosphate (LFP) is the active cathode material 14) may be assembled is described below. This particular example compares a standard energy cathode (see the prior art configuration of FIG. 2 for reference) to an energy cathode loaded with nickel-coated precision chopped fiber, per U.S. Pat. No. 11,527,756 (see the prior art configuration of FIG. 3 for reference), and to a lithium iron phosphate cathode 12 built upon nickel-coated carbon nonwoven 54, as taught herein (see the configuration of FIG. 8 for reference). It should be noted that this teaching is exemplary and not limiting. Those skilled in the art, armed with the disclosures and teachings herein, may apply such disclosures and teachings to other battery designs.

It should be understood that any active cathode material 14 may be used so long as the selected metal or metal coating will survive the battery operating voltage and chemistry. For instance, the metal selected may need to be aluminum for cathodes 12 that operate at higher voltages such as requiring an aluminum-coated fiber as taught in U.S. Pat. No. 11,527,756. Further, various improvements in conductivity, energy and power may be achieved by selecting a metal or metal-coated nonwoven 54 or by designing a nonwoven 54 of different thickness, thus resulting in a thicker cathode 12 capable of greater energy and power density, or by incorporating technology disclosed and taught herein into the anode 16, or into cathodes 12 and/or anodes 16 of completely different chemistries.

Step 1—Selection of the nickel-coated nonwoven (NiNW). For this example, an 8 gsm (gram per square meter) carbon nonwoven structure 54 that had been coated by chemical vapor deposition (CVD) with 12 gsm of nickel was selected. This sheet was 0.002″ thick and 89% porous, meaning that its volumetric carbon content was 11%. If more or less conductivity is desired, then more or less nickel coating is applied. If a thicker or thinner film is desired, then a thicker or thinner base nonwoven structure 54 is chosen, or multiple layers of nonwoven structure 54 are applied. If nickel is not compatible at operating voltages, then another metal may be selected. For example, aluminum has been proven as the metal of choice for higher voltages. Further, fiber 52 and nonwoven structures 54 have been aluminum-CVD coated.

Step 2—Installation and adhesion of the NiNW to the underlying foil. A solution of the binder (in this case polyvinyl difluoride, or PVDF) and the solvent (in this case, n-methyl-pyrollidone, or NMP) was made at 10%. But the concentration may be any percentage to be found suitable. A thin layer (less than a mil) of this solution is spread evenly onto the base foil current collector 40. The dry conductive nonwoven structure 54 is then placed on and pressed into this wet, sticky adhesive solution. It is then placed in a drying oven, with or without clamping.

Step 3—Infusion with cathode (or anode) material. The dried assembly can then be infused with the active battery paste (i.e., active electrode material 38 (active cathode materials 14 for a cathode 12 or active anode material 18 for an anode 16)) by any suitable self-leveling method (or a mechanically leveled method), which is further assisted by the consistent thickness of the open NiNW 54. After this step, the ribbon is again dried.

Step 4—Second addition of active material, if needed. No further addition of the active battery paste (active electrode material 38) is needed if the active battery paste (active electrode material 38) is infused such that after drying the thickness of the active battery paste material equals the thickness of the NiNW 54. However, optionally, more active battery paste (active electrode material 38) may be infused if there is still unfilled space within the nonwoven 54.

Step 5—Surface sanding (Optional). The NiNW 54 surface fibers 52 may be sanded to uniformly expose the conductive NiNW 54 fibers 52. However, this step is considered optional for some battery designs where the desired conductivity is achieved without sanding. If step 3 is designed correctly, then neither steps 4 nor 5 are needed.

Of course, all of these steps are readily adaptable to current industrial scaled-up and continuous processing.

After being fabricated by the process above, the through-thickness volume resistivity of the film was measured. This measurement was also taken for the standard cathode film (see FIG. 2) and for the NiPCF loaded film (see FIG. 3). The results of these measurements are in Table 1 below.

TABLE 1
Comparison of Through-Thickness Resistances
of Standard Film, NiPCF film, and NiNW film:

| | | Typical resistance- ohm cm |
|---|---|---|
| | Thickness | ASTM method D2739 |
| Film type | microns | modified |
| Standard cathode (e.g., FIG. 2) | 75 | 3260 |
| NiPCF in cathode (e.g., FIG. 3) | 75 | 1123 |
| NiNW in cathode (e.g., FIG. 8) | 90 | 28 |

Of course, the NiNW 54 (because of its strength and stiffness) may be configured to be much thicker, has been made up to 700 microns, and is believed that greater thickness may be achieved. Further, there are indications that thicker NiNW 54 will be viable if a particular application requires greater thickness. For example, applicant has made porous refractory structures the are 95% open that are one-inch thick, as well as metal foam that is 97% open having a one-inch thickness. These examples suggest that the NiNW 54 may be built to at least one-inch thick or more.

### Aluminum Nonwoven

At higher operation voltages, for instance 3.8 to 4.2 V lithium-ion batteries, metallic nickel will not survive above 3.76 V against lithium. However, aluminum-coated fibers 52 have been demonstrated to survive 4.2 V operating voltages. Hence, in batteries having higher operation voltages, aluminum coated fibers 52 have demonstrated operational stability.

While specific embodiments and applications of the present invention have been described, it is to be understood that the invention is not limited to the precise configurations and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A battery electrode with enhanced electrical conductivity for use in a battery, the battery electrode comprising:
an active electrode material; and
a conductive nonwoven structure into which the active electrode material is infused, the conductive nonwoven structure being selected from the group consisting of metal nonwoven structures and metal-coated nonwoven structures.

2. The battery electrode of claim 1, wherein the conductive nonwoven structure comprises a nonwoven structure of metal fibers, the metal fibers being selected from the group of metals consisting of nickel, aluminum, copper, and silver.

3. The battery electrode of claim 1, wherein the conductive nonwoven structure comprises a metal-coated nonwoven structure and the metal used in coating the nonwoven structure is selected from the group of metals consisting of nickel, aluminum, copper, and silver.

4. The battery electrode of claim 3, wherein the metal-coated nonwoven structure is a metal chemical vapor deposition coated nonwoven structure (metal-CVD coated nonwoven structure).

5. The battery electrode of claim 1, wherein the conductive nonwoven structure is secured to a foil current collector.

6. The battery electrode of claim 1, wherein the battery electrode is a cathode, and the conductive nonwoven structure is infused with an active cathode material.

7. The battery electrode of claim 6, wherein the active cathode material further comprises a conductive additive dispersed within the active cathode material, the conductive additive comprising precision chopped, metal-coated fibers.

8. The battery electrode of claim 6, wherein the active cathode material further comprises a branching metal additive dispersed within the active cathode material, the branching metal additive being selected from the group of branching metal additives consisting of branching nickel powder and branching nickel strands.

9. The battery electrode of claim 1, wherein the battery electrode is an anode, and the conductive nonwoven structure is infused with an active anode material.

10. The battery electrode of claim 9, wherein the active anode material further comprises a conductive additive dispersed within the active anode material, the conductive additive comprising precision chopped, metal-coated fibers.

11. The battery electrode of claim 9, wherein the active anode material further comprises a branching metal additive dispersed within the active anode material, the branching metal additive being selected from the group of branching metal additives consisting of branching nickel powder and branching nickel strands.

12. A method for assembling a battery electrode with enhanced electrical conductivity for use in a battery, the method comprising the steps of:
selecting a conductive nonwoven structure, the conductive nonwoven structure being selected from the group consisting of metal nonwoven structures and metal-coated nonwoven structures; and
infusing an active electrode material into the conductive nonwoven structure.

13. The method of claim 12, further comprising the step of securing the conductive nonwoven structure to a foil current collector.

14. The method of claim 12, wherein the conductive nonwoven structure comprises a nonwoven structure of metal fibers, the metal fibers being selected from the group of metals consisting of nickel, aluminum, copper, and silver.

15. The method of claim 12, wherein the conductive nonwoven structure comprises a metal-coated nonwoven structure and the metal used in coating the nonwoven structure is selected from the group of metals consisting of nickel, aluminum, copper, and silver.

16. The method of claim 12, wherein the conductive nonwoven structure comprises a metal-coated nonwoven structure formed from fibers coated with a metal coating prior to forming the fibers into a nonwoven structure.

17. The method of claim 12, wherein the conductive nonwoven structure comprises a metal-coated nonwoven structure formed from fibers coated with a metal coating after forming the fibers into a nonwoven structure.

18. The method of claim 17, wherein the metal-coated nonwoven structure is a metal-CVD coated nonwoven structure.

19. The method of claim 12, wherein the active electrode material infused into the conductive nonwoven structure is an active cathode material.

20. The method of claim 12, wherein the active electrode material infused into the conductive nonwoven structure is an active anode material.
